(19) United States
(12) Patent Application Publication
(10) Pub. No.: US 2009/0195655 A1
(43) Pub. Date: Aug. 6, 2009

(54) REMOTE CONTROL VIDEO SURVEILLANCE APPARATUS WITH WIRELESS COMMUNICATION

(76) Inventor: Suprabhat Pandey, Fairfield, OH (US)

Correspondence Address: Frederick H. Gribbell, 6675 TAYLOR ROAD, CINCINNATI, OH, 45248, US

(21) Appl. No.: 12/120,360

(22) Filed: May 14, 2008

Related U.S. Application Data
(60) Provisional application No. 60/930,362, filed on May 16, 2007.

(51) Int. Cl. H04N 7/18

(52) U.S. Cl. 348/158; 348/E07.085

(57) ABSTRACT

A remote control video surveillance apparatus is disclosed that includes a video camera and other types of sensors that communicate sensed data to other computers using wireless Internet functionality. The remote unit includes a cellular telephone transceiver so that it can be used in remote areas, or can be used on a mobile platform; in both cases, it does not require any hard-wired cable connectivity. The remote unit acts as a video surveillance platform that communicates over the cellular network to the Internet, and from there to a base station computer. The remote unit has a dynamic IP address, while the base station computer has a static IP address. User computers can also log into the remote unit through the base station via the Internet, and then receive data from the remote unit.

### CROSS-REFERENCE TO RELATED APPLICATIONS

The present application claims priority to provisional patent application Ser. No. 60/930,362, titled “REMOTE CONTROL VIDEO SURVEILLANCE APPARATUS WITH WIRELESS COMMUNICATION,” filed on May 16, 2007.

### TECHNICAL FIELD

The present invention relates generally to surveillance equipment and is particularly directed to wireless surveillance platform of the type which can be remotely controlled over a cellular network. The invention is specifically disclosed as mobile or stationary self-contained video surveillance platform that communicates with a remote user using a cellular network and wireless Internet technology.

### BACKGROUND OF THE INVENTION

U.S. Pat. No. 6,335,753 discloses a wireless communication video telephone system in which a wireless communication link can be established between first and second video telephones. A digital camera can capture a digital image and transmit this captured digital image to a microprocessor in one of the video telephone units. The wireless communication device can be a satellite dish, a cellular communication unit, or a different type of device for establishing a wireless communications channel.

U.S. Pat. No. 6,518,881 discloses a digital electronic communication system for a mobile unit such as a law enforcement vehicle. A modular communications system is supported by an on-board computer, and the system provides audio, video, graphic, text, and positioning communication capability. The system includes scanners and sensing devices, such as bar code readers, magnetic strip readers, and fingerprint scanners to permit enhanced on-site investigation support. Multifunction displays, a recording system, and a full function printer further enhance the capability for the field personnel. GPS signals can be integrated into this system to permit location and heading detection and monitoring information. The communication system can be over a private radio band, or over other types of radio systems, including cellular telephones.

### SUMMARY OF THE INVENTION

Accordingly, it is an advantage of the present invention to provide a remote unit that has a video camera mounted thereto, and as a cellular telephone connection that can ultimately be connected into the Internet, so that live video images can then be transferred either to a base station or to a user computer at a different remote location.

It is another advantage of the present invention to provide a remote unit that includes a video camera that can be remotely commanded to change its aiming capabilities, including zoom/wide angle capabilities, and panning or tilting, and which can communicate live video data using a cellular telephone communications system to a remote user computer and/or to a base station.

It is yet another advantage of the present invention to provide a remote unit that includes a video camera that can be mounted at a remote location and powered by solar energy (or other electrical power source), which can communicate using cellular telephone technology without any hard-wiring whatsoever, and can send video images to a remote base station and/or to a remote user computer.

It is still another advantage of the present invention to provide a remote unit that has a video camera that can output live video images, in which the remote unit also includes a cellular router that communicates to a cellular network and a cellular transceiver, and can communicate to a data recorder to record live video data.

It is a further advantage of the present invention to provide a remote unit that has a video camera that can provide live video images and send them to a cellular router that will then transmit them through a cellular telephone network, in which the remote unit also can receive data from other sensing devices, including radiation sensors, radioactivity sensors, electronic nose-type sensors (for detecting chemical signatures), certain types of acoustic sensors, motion detector sensors, and other various types of sensors that could be used in a surveillance application.

It is yet a further advantage of the present invention to provide a remote unit that includes a video camera that can output live video data to a cellular telephone network, in which the remote unit is mobile and can be moved from one location to another, and also has a dynamic IP address for connecting to the Internet, and further can “point to” a remote base station that has a fixed IP address so as to communicate with that base station, and later to receive instructions and commands from either the base station or from remote computers that are in communication with the remote unit by use of the base station.

It is still a further advantage of the present invention to provide a surveillance system that can have one or more remote units that are at different locations from a base station, which itself can be at a different location than one or more user computers, in which all of these devices can be connected to one another using the Internet, and in which the remote units communicate to the Internet using cellular telephone communication links; the remote units have a video camera that can output live video data, and also have other types of sensors that can transmit live sensor data, in which the remote units have a dynamic IP address and, when activated, will attempt to communicate to the base station which has a fixed IP address, and in which the user computers can also communicate to the base station via the Internet, and then to one or more of the remote units in the overall surveillance system.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a remote control video surveillance apparatus is provided that uses wireless communication to send real time video data to a base station, in which a cellular telephone network is used to wirelessly connect the remote unit to the INTERNET.

In accordance with another aspect of the present invention, a mobile video surveillance system that includes a mobile video unit is provided, in which the mobile video unit comprises: a video camera that detects image information, and generates a first video signal; a first computer that receives the first video signal from the video camera, and outputs a second video signal that is based upon the first video signal; a video data recording circuit that receives the second video signal from the processing circuit, and stores video information corresponding to at least a portion of the second video signal in a bulk memory storage device; a wireless transmitter that receives the second video signal from the first computer and, substantially in real time, transmits to a network video information corresponding to at least a portion of the second video signal; and a source of electrical power for the video camera, the first computer, the video data recording circuit, and the transmitter.

In accordance with yet another aspect of the present invention, a mobile video surveillance system is provided, comprising: (a) at least one mobile video unit having a first computer, a first memory circuit, a first communications port that is in communication with the network by way of a wireless transmitter/receiver, a video camera that generates a first video signal, and a first data recorder for storing video information; wherein: (i) the first computer functions as a server for communicating with the network; (ii) the first computer receives the first video signal and creates a second video signal that is stored in the first memory circuit; (iii) the first computer receives the first video signal and creates a third video signal that is communicated to the first communications port, the wireless transmitter/receiver, and the network substantially in real time; and (iv) the first communications port receives messages from the network, by way of the wireless transmitter/receiver, and directs the received messages to the first computer, in which the received messages may contain instructions for controlling the video camera and the first data recorder, using output signals provided by the first computer; and (b) a base station that is physically separated from the at least one mobile video unit, having a second computer, a second memory circuit, a second communications port that is in communication with the network, and a first user interface that includes a first video monitor and a first user input device; wherein: (i) the second communications port receives the third video signal, and directs it to the second computer; (ii) the second computer displays the third video signal on the video monitor substantially in real time; and (iii) the first user input device allows a user to enter commands that are communicated to the first computer of the at least one mobile video unit, by way of the second computer, the second communications port, the network, and the first communications port.

In accordance with still another aspect of the present invention, a method for maintaining remote video surveillance is provided, in which the method comprises the steps of: (a) providing a base station that is in communication with a network of computers, the base station having a first computer that has a fixed IP address; (b) providing a remote unit that is in communication with the network of computers, the remote unit having a second computer that has a dynamic IP address, a wireless transmitter/receiver, a video camera, and a video data recorder, wherein the remote unit is physically separated from the base station; (c) initializing the base station and initializing the remote unit; (d) transmitting the dynamic IP address from the remote unit to the base station, using the fixed IP address of the base station; and (e) after the base station recognizes the remote unit, transmitting video data from the remote unit to the base station.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a diagrammatic view of a remote control video surveillance system that shows two different remote units mounted on vehicles, a cellular telephone network that communicates to the vehicles and also communicates to an Internet connection, a base station also connected to the Internet, and at least two user computers that are also connected to the Internet, as constructed according to the principles of the present invention.

FIG. 2 is a block diagram of some of the important hardware components that are used in a first embodiment of a remote unit found in the surveillance system of FIG. 1.

FIG. 3 is a block diagram of some of the important hardware components that are used in a second embodiment of a remote unit found in the surveillance system of FIG. 1.

FIG. 4 is a flow chart of many of the important steps performed by the various computer components used in the remote surveillance system of FIG. 1.

FIG. 5 is a flow chart of other important steps performed by the various computer components used in the remote surveillance system of FIG. 1, particularly related to maintaining communications between a base station and a remote unit.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

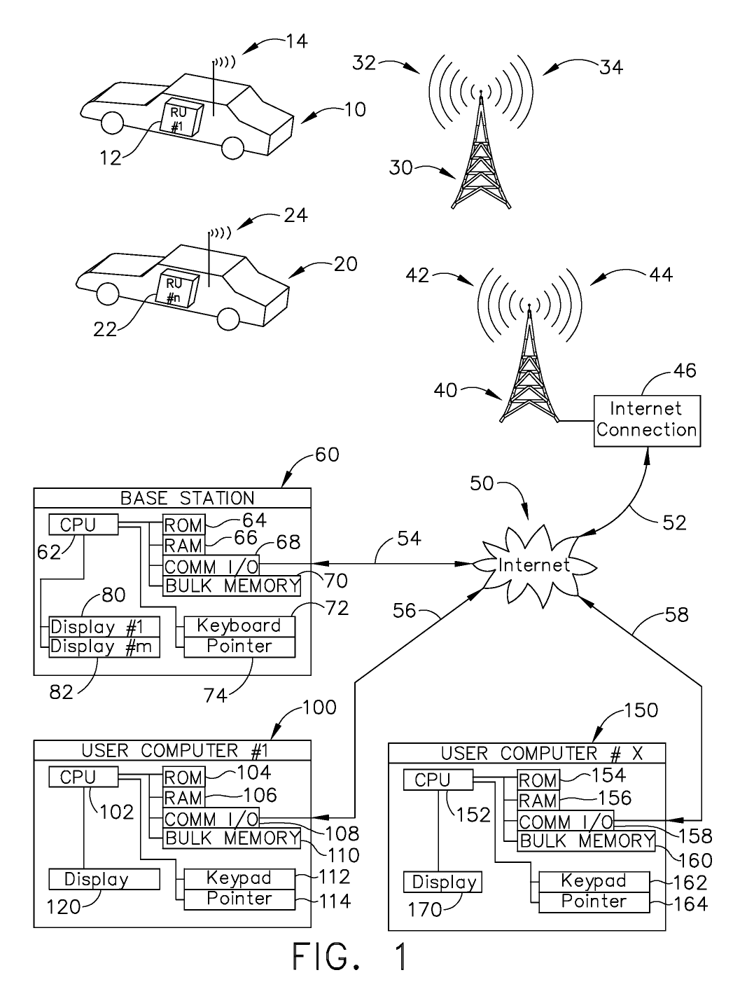

Referring now to FIG. 1, a vehicle generally designated by the reference numeral 10 is depicted as having a remote unit 12 that communicates wirelessly using a radio link 14. In general, this radio link could use cellular telephone technology, and the radio wave 14 can communicate to a cellular tower 30, being received over the radio link at 32. Cell tower 30 can communicate to a further cell tower 40 using radio links 34 and 42, for example, and cell tower 40 can further communicate to other upstream or downstream cell towers using a radio link 44.

Cell tower 40 is one that includes a connection to the INTERNET®, in which this Internet connection is designated at 46. In FIG. 1, this Internet connection is provided using a non-wireless link 52 to the actual Internet “network of computers” which is generally designated by the reference numeral 50. It will be understood that these connections to and from the Internet could be wireless, as well as some type of electrical wire or optical cable communications medium. Furthermore, it will be understood that many different communications protocols could be used to increase the security or the throughput of the wireless communications messages being used in the present invention. For example, the use of a particular communications protocol, such as WiMAX, could increase the throughput rate of the data.

FIG. 1 also depicts a second vehicle 20 that contains a second remote unit 22, in which this second remote unit communicates wirelessly to a cell tower using a radio signal 24. As is understood by the second remote unit having the designation “RU #n”, there can be many different remote units, and the system is not artificially limited to a specific maximum number of such remote units. Also it will be understood that these remote units are not always mobile, but could also be mounted in a fixed location, rather than mounted in a vehicle. This will be discussed in greater detail below.

FIG. 1 includes a base station, generally designated by the reference numeral 60. This base station could be fixed at a particular building or location, or itself could be mobile so that the person utilizing the base station can move that base station around from one location to another, if desired. In many uses of the present invention, the base station will be fixed at a police headquarters building, for example.

Base station 60 communicates to the Internet 50 using a link 54. Again, it will be understood that this link 54 could either be a hard-wired link (to a building, for example) or it could be a radio link to enable the base station 60 to be utilized in a mobile manner. Furthermore, base station 60 could be contained in a laptop computer arrangement, in which that laptop computer could be used in a police headquarters building on a first occasion, then unplugged and moved to a different building (such as the police chief's house) and then re-plugged into electrical and communication ports at the second location. In that situation, the communications link 54 would not necessarily have to be wireless, but could be hardwired at two different physical locations, if desired.

Base station 60 will typically contain some type of processing circuit designated as a “CPU” 62, along with memory elements, such as Read Only Memory (ROM) at 64, Random Access Memory (RAM) at 66, and also a bulk memory device 70. It will be understood that the bulk memory device 70 could be any number of types of memory storage units, such as a hard disk drive or an optical disk drive, particularly a read/write capable optical disk drive. CPU 62 would also have an interface using a communications input/output circuit 68, so that it can communicate to the Internet via the signal link 54.

Base station 60 would typically contain a keyboard device 72 and a pointer device 74, such as a mouse. In addition, the base station 60 would contain at least one display, and on FIG. 1 there is a first display 80 and a second display 82, in which the second display is described as being “Display #m” which indicates that there can be many different displays used at the base station computer. It will be understood that base station 60 can be in communication with more than one remote unit in real time, hence the reason for having multiple displays so that each of the remote units can be simultaneously monitored, if desired. Base station 60 can comprise of commercial technology for the most part, in which its major components are part of a personal computer system, a laptop computer system, or a network business computer platform, or even a more complex computer platform if desired. The greater the number of remote units to be simultaneously monitored with their surveillance data displayed simultaneously, the more complex the base station computer platform 60 will likely be.

Another hardware component depicted in FIG. 1 is a user computer, generally designated by the reference numeral 100. This user computer can be a laptop computer, if desired, or can be some other type of mobile communications device that has computing capabilities, such as a picture cell phone, a PDA, a wireless Internet cell phone, or even a stationary personal computer that is well known in today's technology. In many surveillance situations, the user computer 100 will have greater capabilities if it is allowed to be used as a mobile unit, such as a laptop or PDA device.

User computer #1 on FIG. 1 contains a central processing unit 102 (i.e., any type of processing circuit), along with associated memory components. In most computers, the typical memory components will include ROM 104, RAM 106, and a bulk memory device 110. The user computer would also have a communications input/output interface 108 so that it can communicate to the Internet over a communications link 56.

User computer 100 would typically also contain a keyboard or a keypad 112 and a pointer device 114. Moreover, it would typically contain a display 120. Depending on the style of computing platform used for user computer 100, the keyboard or keypad could be a condensed version of a full keyboard, the pointer device may not be a true “mouse” but might instead be a pointing device used with a type of touch screen display, and the display itself could be a very small video display unit, as compared to a comparatively large LCD screen that might be found on a laptop computer. All of these devices can be used in various combinations to make up the user computer 100, without departing from the principles of the present invention.

A second user computer generally designated by reference numeral 150 is depicted on FIG. 1, and is designated “USER COMPUTER #X”, which indicates that there can be multiple different user computers that are linked into the surveillance system of FIG. 1. In the user computer 150, there also is a CPU 152, various memory elements such as ROM 154, RAM 156, a bulk memory device 160, as well as a communications interface 158, which communicates to the Internet via a communications link 58. In addition, this user computer 150 would include some type of keyboard or keypad 162, a pointer device 164, and a display 170.

It will be understood that there could be multiple user computers communicating with a single base station, and further communicating with a single remote unit, if desired. More likely, however, there will be a separate user computer for each individual remote unit that is connected into the base station system, and for example, the system of FIG. 1 shows two different remote units and two different user computers. User computer 100 could be in communication with remote unit 12, while user computer 150 could be in communication with remote unit 22, or vice versa. The base station 60 facilitates the communications between the user computers and the remote units, as will be discussed in greater detail below.

In one exemplary use of the present invention, the remote unit can be concealed from view, and the vehicle 10 could be left at a prospective crime scene, or as an alternative, the concealed remote unit device could be used for covert surveillance, regardless of whether a crime might be committed or not.

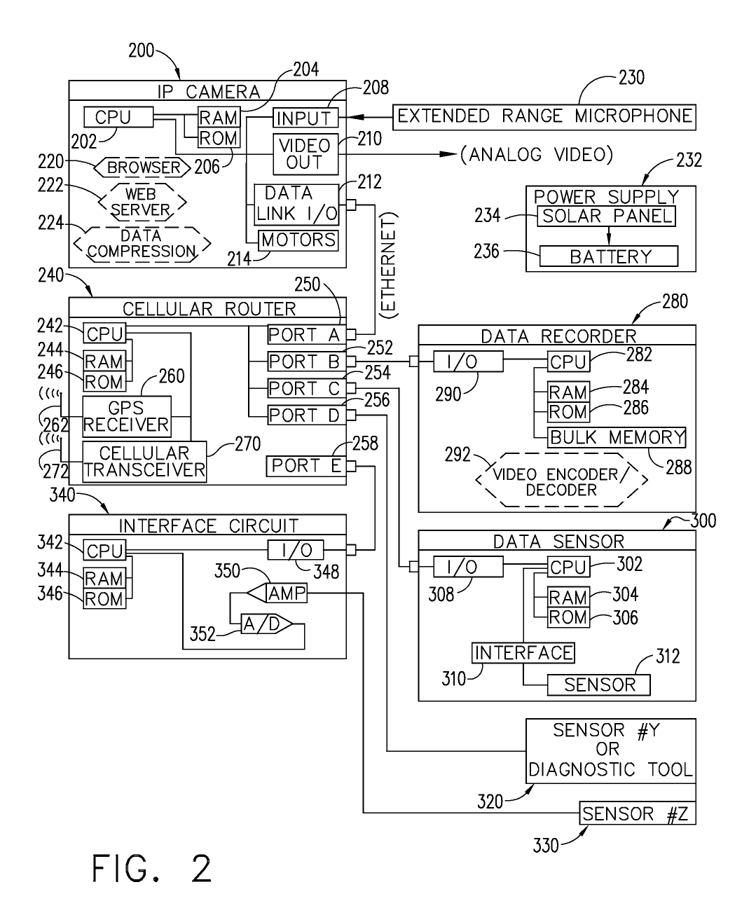

Referring now to FIG. 2, the major hardware components, and some software components, are depicted for a first embodiment remote unit that is used in the present invention. An Internet Protocol camera, generally designated by the reference numeral 200, is provided to output live video information. An example of this type of IP camera is a Sony Model Number SNCRZ25, or an Axis Model 214. Such cameras include a video sensor, and typically include a microphone. Moreover, these IP cameras also have an Ethernet™ output signal.

In FIG. 2, IP camera 200 includes a processing circuit (CPU) 202, and certain memory elements, such as RAM 204 and ROM 206. The video data signal is sent through a video output interface 210, and this is a signal that is in an analog video format. The same video information can be digitized and sent out through the Ethernet port using a data link input/output interface circuit 212. IP camera 200 can also contain an input circuit 208 to allow an extended range microphone 230 to be used, and to have its audio output signal directed to this interface circuit 208.

The highly capable IP camera 200 that has been described also contains a set of motors 214. This allows the camera to be able to pan, tilt, and zoom. These controls could be manual, but in the remote surveillance system of the present invention, these capabilities are typically commanded remotely by signals coming in to the data link input/output port 212 over the Ethernet link. Commands can also be received at the IP camera 200 to take single frames of video data, when desired.

IP camera 200 also includes certain software functions, such as a browser function 220, a web server function 222, and a data compression routine 224. These software functions essentially allow the IP camera 200 to be controlled using signals that originally were generated through an Internet link, and also, particularly using the data compression routine 224, allow the IP camera 200 to output a compressed video signal that will use the rather limited amount of bandwidth that will be made available to the IP camera (via the cellular network), yet will nevertheless contain a great amount of video information.

The remote unit of FIG. 2 also contains a power supply 232. In general, this would be a battery powered device using a battery 236, which could be a 12 volt car battery, if the remote united is mounted to an automobile. As an alternative, the remote unit could be mounted on a trailer, and that trailer could have a solar panel 234 to provide energy to the battery 236. As a further alternative, the remote unit could be mounted at a fixed location, such as on a pole, and the solar panel 234 could be mounted on that same pole. An example installation for this arrangement could be used to monitor water level of a river or a stream, for example. The battery 236 provides power for the IP camera 200 which would be aimed at the river or stream being monitored. The video data could then be transmitted over a cellular network and the Internet to a user computer 100 or a base station 60, as desired.

It will be understood that more than one or two models of various types of IP cameras are available with additional features compared to those discussed above. For example, the Sony camera noted above can have an analog video output, a digital video output, or a digital wireless LAN output, such as Bluetooth. Other manufacturers and models of such IP cameras could also have the same types of outputs, plus other ones that will be invented in the future.

The remote unit of FIG. 2 also contains a cellular router, generally designated by the reference numeral 240. This cellular router is also sometimes referred to as a transceiver, and an exemplary cellular router is one made by Digi, Model Number “DigiConnect WAN port.” This Digi model is a particularly useful model, since it is constructed for MIL-SPEC, and thus can be used in cold weather if desired.

Cellular router 240 includes a computer processing circuit (CPU) 242, and some type of memory devices, such as RAM 244 and ROM 246. Cellular router 240 can include a GPS (Global Position Sensor) receiver 260, which would have an antenna 262, and also a cellular transceiver 270, which would have its own antenna 272. These components 260 and 270 would become important particularly if the remote unit is mounted on a mobile device, such as an automobile. The cellular transceiver 270 would become important even if the remote unit was at a fixed location, if that fixed location was not close to existing telephone land lines, for example, along a river bank, or at another location that is not close to any major town or road.

Cellular router 240 also includes a number of input/output ports, which can be numbered in software, if desired. For the purposes of this description, the ports are lettered A-E. PORT A at 250 is an Ethernet port that is connected to the digital video output circuit 212 of the IP camera 200. PORT B at 252 is connected to a data recorder 280, which will be discussed in greater detail below. PORT C at 254 is connected to a data sensor 300, which will be discussed in greater detail below. PORT D 256 is connected to another data sensor 320, or perhaps it could be connected to a diagnostic tool, which will be discussed in greater detail below. PORT E at 258 is connected to an interface circuit 340, which itself is connected to a different sensor 330. These will be discussed in greater detail below.

After the cellular router 240 has received the video data signal, that signal can be transmitted through the cellular transceiver 270 to a cellular telephone network, and from there it can be directed to many different user computers, and/or to a base station 60, as seen on FIG. 1.

A data recorder 280 can be an optional piece of equipment for the remote unit 12. However, this can be a handy device, and if the surveillance purpose is to collect evidence of crimes, an on-site data recorder could be vital. In FIG. 2, data recorder 280 includes an input/output interface circuit 290, which connects the video signals from PORT B of the cellular router to a processing circuit (CPU) 282. This processing circuit 282 will have associated RAM 284 and ROM 286. It will also typically have an associated bulk memory device 288, which could be a hard disk drive having sufficient speed and memory capacity to store video data that has been detected by the IP camera 200.

Data recorder 280 can also contain an important software component 292, which would be a video encoder/decoder routine. This video encoder/decoder routine will allow the video data that has been compressed and output from the interface circuit 212 of the IP camera 200 to be stored in various different formats on the bulk memory device 288, if desired. For example, the video data could be decoded and processed to a format used in DVD-R or DVD+R video storage devices.

The data sensor 300 can be capable of detecting various forms of parameters, such as detecting motion, detecting radiation or radioactivity, or acoustic energy in certain frequency ranges, or perhaps it can act as an olfactory sensor for “sniffing” for bombs, for example. Such bomb sniffer sensors are also sometimes referred to as “electronic noses,” which actually are not true smell sensors, but are used for detecting certain chemical signatures.

In the data sensor 300, a processing circuit (CPU) 302 controls the overall device, and has associated RAM 304 and ROM 306. There is also a communications input/output interface circuit 308 that allows the CPU 302 to transmit information back to the cellular router at PORT C (at 254). The actual sensing element 312 would probably have an analog output, so this is directed to an interface circuit 310 that will digitize the information and send it along so it can be processed by the CPU 302. Thus the information will be digitized and converted into an Ethernet format by the data sensor components.

In the remote unit 12, there can be multiple data sensors, and this is represented by the “SENSOR #Y” that is designated by the reference numeral 320. This can be another data sensor just like the data sensor 300, having a CPU, a sensing element with an interface to convert that information into a digitized format, as well as an input/output communications interface to convert the data to an Ethernet format. Moreover, sensor 320 could be of a different type of sensing device, and as noted above, there can be many different types of sensing devices used on the remote unit 12. For many police surveillance situations, a motion detector and an electronic nose could be two different types of sensors that would be quite useful in many situations.

Alternatively, PORT D at 256 of the cellular router could be used to interface to a diagnostic tool, in case any type of software maintenance or other testing of the cellular router needed to be performed for the remote unit 12. This diagnostic tool could also perform maintenance on the software components of the IP camera 200, using the data link through the cellular router 240. As an optional diagnostics port, PORT D could receive instructions from a remote device such as the base station 60 or one of the user computers 100, 150, for example. This PORT D could be connected to a local telephone line via an Ethernet-to-telephone interface, or it could be connected to a cellular network using an Ethernet-to-cellular transmitter interface, if desired. In addition, remote diagnostic functions could be achieved using the cellular transceiver 270 and cellular antenna 272, and could thus receive messages from either the base station or one of the user computers, and not tie up one of the PORTS A-D, if desired.

The cellular router 240 generally receives inputs using its various I/O ports by polling those ports. In that configuration, the cellular router acts as a LAN server and performs the transceiver function between the various sensing devices and the cellular network using the communications signal 14 for remote unit #1, for example. The transceiver settings themselves could be adjusted from a remote location, such as the base station or one of the user computers if desired, and such commands could be received at the cellular transceiver circuit 270. The cellular router 240, acting as a transceiver, can have multiple port configurations, including Ethernet, RS-232, and RS-422 as noted above. In addition, the transceiver ports could be of the RS-485 protocol, or could be USB ports, for example.

FIG. 2 also includes a “SENSOR #Z” which is generally designated by the reference numeral 330. Sensor 330 could be a type of sensor that does not have a digitized output, and so its output is run into an interface circuit 340. Such an interface circuit would typically have an amplifier stage 350 and then the signal would be digitized by an analog-to-digital converter circuit 352. Now that the sensing output signal has been converted to a digitized format, it can be directed to a processing circuit (CPU) 342 of the interface circuit device 340. This CPU 342 would have associated RAM 344 and ROM 346, and would have an output circuit that runs through an input/output interface circuit 348. This output circuit could be of an Ethernet format to run into PORT E (358), or it could be of a different type of format, such as RS-232 or RS-422, for example.

Using one or more sensors such as the SENSOR #Z at 330, along with an associated interface circuit 340, the remote unit 12 could be interfaced to virtually any type of sensing device that has an electrical output.

With respect to the hardware depicted on FIG. 2, it will be understood that some of these components can be combined into a single computer system, as desired by the system designer. For example, a fairly standard personal computer (such as a laptop computer) could be used to perform the functions of both the cellular router 240 and the data recorder 280. In such a system, the personal computer would still have a CPU 242, random access memory 244 and read only memory 246, a GPS receiver 260, and a cellular transceiver 270. Since a standard computer system could be used in this alternative embodiment, the GPS receiver and the cellular transceiver could each be “plug-in” cards or modules that can either mate to the PC's I/O bus, or could be “attached” by use of a USB port, for example.

This alternative “PC embodiment” could still communicate to the IP camera by use of an Ethernet link between a port 250 and a data link input/output device 212 (as seen on FIG. 2). This PC embodiment could also communicate (via I/O ports) to data sensors and interface circuits, such as those depicted at the reference numerals 300, 320, 330, and 340 on FIG. 2. These I/O ports could be arranged to be any desired type of communication link, or merely a pair of wires, as appropriate for the type of data sensor and interface circuits that would be used with this alternative PC embodiment.

The data recorder 280 depicted on FIG. 2 could be wholly subsumed within the alternative “PC embodiment” computer. In other words, there would not be a need for a separate CPU 282, separate RAM 284, or separate ROM 286. Instead, the CPU 242, RAM 244, and RAM 246 of the alternative PC embodiment computer could suffice to handle all of the cellular router functions as well as all of the data recorder functions. There would still be a bulk memory device 288. More specifically, a bulk memory device could be an internal hard disk drive that is contained within the alternative PC embodiment computer, if desired. However, an external hard disk drive could also be used, particularly to store video information that represents video data that is to be recorded after it has been received from the IP camera 200. The external hard disk drive would receive the video feed information, and would allow the stored video data to be easily removed from the remote unit system (i.e., by removing the external hard disk drive), so that this remote video data could be taken to another site for data analysis. At the same time, a different external hard disk drive could then be “plugged in” to the remote unit system, and begin communicating with the alternative embodiment PC computer (that contains the functions of the cellular router 240 and the data recorder 280).

As would be expected, there would not necessarily need to be a separate port B (at 252) communicating to an I/O module 290, as depicted in FIG. 2. Instead, the CPU 242 of the alternative PC embodiment computer could directly control the hard disk drives of the bulk memory 288, whether there is a single internal hard disk drive, or there is both an internal hard disk drive and an external hard disk drive, as discussed above.

If desired, a video encoder/decoder module or routine could still be used with the alternative PC embodiment computer system, so that the video data can be stored in various formats on the hard disk drives of the alternative PC embodiment computer. This is a matter of system choice, as determined by the system designer for a specific remote unit. Typically, a video encoder/decoder (such as that depicted at reference numeral 292 on FIG. 2) would be quite useful, so that the video data stored on the external hard disk drive is stored in a format that can be used with DVD-R or DVD+R video formats, for example.

The external hard disk drive could be “plugged in” to the alternative PC embodiment computer by any standard technique, such as the use of a USB cable, or other type of standard interface. Furthermore, there could be multiple external hard disk drives, as desired by the system designer of a specific remote unit. In this manner, the first external hard disk drive could become filled with video data, and then the system controller (i.e., CPU 242) would have the ability to automatically begin storing further video data on a second external hard disk drive, as desired. This might be important in situations where the remote unit cannot be easily accessed on a frequent basis, for whatever reasons.

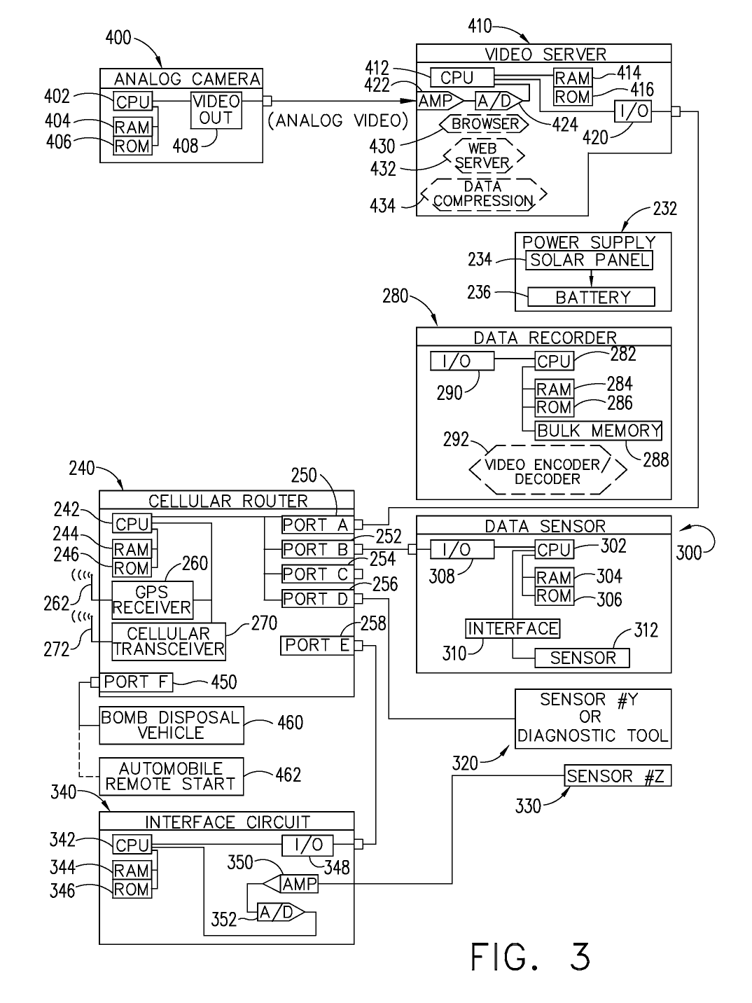

Referring now to FIG. 3, the remote unit 12 is depicted with a standard analog video camera 400, which is not an IP camera, but is a standard video camera that has an analog video output signal. This type of camera is much less expensive, and would allow the present invention to be used in certain locations that are higher risk, where lesser expensive components are desirable. The analog camera 400 could also be equipped with a “pinhole” lens, and this pinhole lens could be positioned at dangerous locations, for example. One possible dangerous location could be used on a bomb disposal robotic arm, which now allows this robotic arm to have the capability of a vision system, which would allow a remote user to see exactly where the robotic arm is being directed and what the robotic arm would be actually “seeing.”

The analog camera 400 can also be made in a very small physical size, and as such, could be body-mounted on a person, such as on the clothing of the person. Alternatively, the analog camera 400 could be used on an unmanned surveillance vehicle, including a vehicle that may be likely to be damaged or destroyed, in which a lesser expensive analog camera would be more suitable than a digital camera, as would be decided by the surveillance system administrator or other supervisory person.

Camera 400 would typically include a processing circuit (CPU) 402 with associated RAM 404 and ROM 406. The CPU would control the video output signal from an output circuit 408, which generates the analog video. This type of analog video signal could be directly viewed on analog TV monitors, or it could be stored on videotape recorders or even DVD-type recorders, in which the DVD recorder could accept analog video data and convert it to digital data before being stored.

A cellular router 240 is once again used in the alternative embodiment depicted in FIG. 3. This cellular router still has its own CPU 242, and potentially could have a GPS receiver 260 and a cellular transceiver 270, each with their own antennas. Cellular router 240 can also have several Ethernet ports, depicted on FIG. 3 as PORTS A-D, and can also have a PORT E that is connected to an interface circuit 340, just like that seen on FIG. 2. On FIG. 3, there is also a data recorder 280 and a data sensor 300 as well as a second data sensor 320 or diagnostic tool, as well as another type of data sensor 330, which are all similar to those discussed above in reference to FIG. 2. FIG. 3 would also have a power supply 232 which again would be powered by a battery 236, which potentially is also provided with energy from a solar panel 234.

The major difference of the systems between FIGS. 3 and 2 is that there is a video server 410 in FIG. 3. This server receives the analog video signal from the analog camera 400 at an amplifier stage 422, and this signal is then converted to a digital format by an analog-to-digital converter circuit 424. This digitized signal can now be manipulated by a processing circuit (CPU) 412, contained in the video server 410. CPU 412 will have associated RAM 414 and ROM 416, and an input/output interface circuit 420. The interface circuit 420 will convert the digitized video signal into an Ethernet format, so that it can be received at PORT A of the cellular router 240.

Video server 410 also includes certain software capabilities, including a browser module 430, a web server module 432, and a data compression routine 434. These software components of the video server 410 perform essentially the same functions as similar components that were contained in the IP camera 200 of the system depicted on FIG. 2.

Now that the cellular router 240 has received the video data signal, it can be transmitted through the cellular transceiver 270 to a cellular telephone network, and from there it can be directed to many different user computers, and/or to a base station 60, as seen on FIG. 1.

On FIG. 2, the cellular router 240 also contains a PORT F at 450. PORT F can have a digital format, but not necessarily Ethernet. For example, it could communicate to other devices using RS-232 or RS-422 data formats. This allows PORT F to communicate to vehicles or devices that are in closer proximity, such as a bomb disposal vehicle 460. PORT F could also, or alternatively, be connected to one of the vehicles 10 or 20 that are depicted in FIG. 1, so that it could control a remote start capability of an automobile, using a logic block 462 on FIG. 3. This remote start would allow an unoccupied automobile which contains one of the remote units, and periodically have that automobile start and stop under remote control, merely to charge the battery of the automobile to allow the remote unit to continue operation. This is an optional feature that would not always be used in many surveillance situations.

With regard to the bomb disposal vehicle 460, the pinhole analog camera 440 lends itself well to such a situation, because the camera itself would be at risk when used in an actual bomb threat situation. This is the main reason why PORT F is depicted on FIG. 3 but not on FIG. 2. One would not normally use an IP camera for a bomb disposal vehicle situation, because the IP camera is quite more expensive than a standard analog camera used as a pinhole lens.

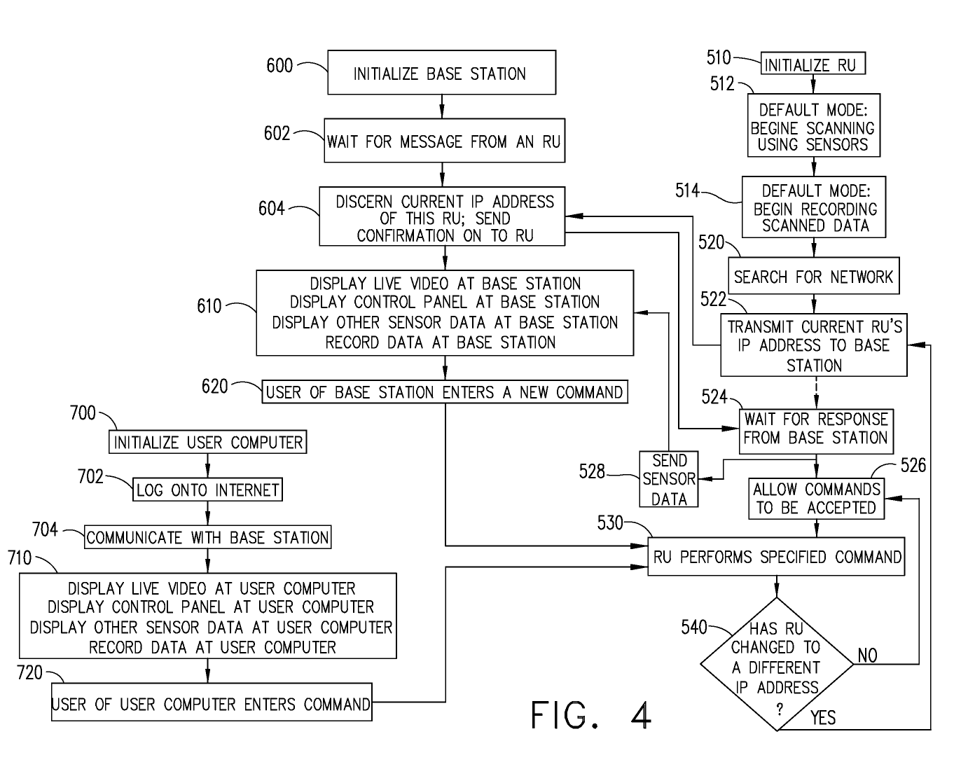

Referring now to FIG. 4, a flow chart of some of the logical operational steps using the present invention is depicted. Beginning with the remote units, a particular remote unit is initialized at a step 510, and then enters a default mode where it begins scanning using its sensors at a step 512. Depending on its programming, another default mode at a step 514 can begin recording the scanned data.

The logic flow now is directed to a step 520 in which the remote unit searches for a network. In the present invention the network typically is a cellular telephone network, which allows the remote unit to be moved to virtually any location in the United States, and also in many other countries, so long as they are within the range of a cellular telephone network. A step 522 now transmits the remote unit's current IP address to the base station 60. As will be understood, if the remote unit moves from one cellular tower zone to another, its Internet address will automatically change, unless a special and more expensive arrangement has been made. It's also possible that the remote unit would have a different IP address even if it has not moved for several hours, because the cellular telephone system might log out the remote unit at one point and then allow it to log in later, but change its IP address at that point. Again, at step 522, the remote unit will periodically transmit its current IP address to the base station. In this manner, the remote unit will continually inform the base station of its current IP address, in case that would have changed by way of the cellular telephone network.

The logic flow is now directed to a step 604 that involves the base station, which will be discussed below in greater detail. The logic flow also is directed to a step 524, directing the remote unit itself to wait for a response from the base station. Once that has occurred, the logic flow is directed to a step 526 in which the remote unit will allow commands to be accepted from the base station, or perhaps from a user computer, which will also be discussed below in greater detail.

Once the remote unit receives a response from the base station at step 524, the remote unit can begin sending sensor data at a step 528. Once that has begun, then step 610 will allow the base station to display live video and other sensor data, as well as the control panel of the remote unit. The sensor output data that is communicated is previously digitized and compressed or encoded, and is fed to the base station which itself is an Internet-enabled network server. The base station server can communicate messages to the cellular router 240 of the remote unit, which is discussed below at a step 530.

Once remote commands have been accepted, a step 530 will have the remote unit perform the specified command. A decision step 540 now determines if the remote unit has changed to a different IP address or not. If not, then the logic flow is directed back to step 526, which will again allow remote commands to be accepted by the remote unit. On the other hand, if the remote unit has changed to a different IP address, then the logic flow is directed back to step 522, wherein the remote unit will transmit its current IP address to a base station.

It will be understood that each remote unit has been pre-programmed with the IP address of a particular base station. Otherwise, the remote unit would not know where to communicate to, and would not be able to link with any base station, for lack of knowledge of its IP address.

On FIG. 4, a step 600 initializes the base station, and the next step at 602 waits for a message from a remote unit. At step 600, the computer of the base station 60 is configured to play the role of a network server as well as being activated to allow remote access for troubleshooting and maintenance. As a network server, it will have broadband connectivity (e.g., DSL, cable, or cellular networks) with a static Internet Protocol (IP) address, in one mode of the present invention. Base station 60 will have several application programs running in the background. This could include an IP address-capturing application that receives current IP addresses of the remote units, using the Internet. Another application program can allow clients (e.g., Internet-enabled user computers) to receive and display appropriate remote unit data. These capabilities will be discussed in further steps of this flow chart.

In step 602, the remote unit message that the base station is programmed to receive can contain data from a number of different sensors, possibly including a video camera, motion detector, acoustical sensor, a chemical signature sensor (such as an “electronic nose”), a radiation sensor, or a radioactivity sensor, as examples. In addition, certain data can be recorded either at the remote unit or at the base station once the base station receives the video live feed.

Once the base station has received a message, a step 604 determines the current IP address of the remote units whose signal has been received, and the base station sends a confirmation message to that remote unit.

A step 610 is now performed at the base station that allows multiple different functions to occur. For example, live video from the remote unit can be displayed at the base station, and the “control panel” of the remote unit can also be displayed at the base station. At step 610, the input sensor information can be viewed on the monitor at the base station by a user of the base station, and this monitor is capable of accessing real time video as well as output data from the various sensors that are connected to the cellular router 240. This sensor data or video data could be accessed from any Internet-enabled device, such as a cell phone, a computer (either a laptop or desktop, or a PDA, etc.) via a web page of the base station itself.

The above control panel is a WINDOWS-type display that contains various functions that can be manipulated by a person at the base station, and can cause the remote unit to perform various commands at a step 620. Common commands would include manipulating the video camera, including changing the pan, zoom, or tilt angle of the camera itself. It could also send a command to take a single frame and store it. In addition, other sensor data from the remote unit can be displayed at the base station computer. Finally, video data can be recorded at the base station, as well as other sensory data. Furthermore, certain troubleshooting functions and diagnostics involving the components of the remote unit can be performed using the base station, at step 620. In addition to diagnostics, the user could change the set-up programming as to how and when the sensors are sampled at the remote unit. After 620 allows a user at the base station to enter a new command, the logic flow is then directed to the step 530 in which the remote unit performs that specified command. As discussed above, this can allow the remote unit to perform multiple different tasks, which could involve various types of sensors other than only the video camera.

On FIG. 4, a step 700 initializes a user computer, such as the user computer 100 or 150 that are depicted on FIG. 1. Once the user computer has been initialized, it attempts to log onto the Internet at a step 702. As noted above, the user computer could be a mobile device, such as a laptop or PDA, or it could be a stationary device, such as a standard personal computer. At step 702, the user computer can either be manually or automatically made to connect to the Internet, depending upon its settings.

The user computer, at a step 704, will attempt to communicate with the base station, now that the user computer has been logged onto the Internet. Once the communication has been established with the base station, multiple different things can occur. At step 704, the client programs on the user computer will have been configured to connect to the base station 60. Once the connection between the user computer and base station has been established, a video feed along with sensor data from one or more remote units 12, 22 will be available for display on the user computer in real time.

A step 710 now allows the live data from the remote unit to be displayed at the user computer. This live data could be run through the base station, using the base station's IP address, or alternatively as an option, the user computer could direct its inquiries to the remote unit's IP address, and directly receive the video feed from that remote unit. Depending on the number of users that wish to monitor various remote units in this system, it might be better to have the live video be sourced from the base station, rather than directly from the remote unit, in view of today's bandwidth restrictions of cellular networks. Another function that can occur at step 710 is to display the “control panel” of the remote unit at the user computer. In addition, other sensor data from the remote unit can be displayed at the user computer. Finally, video data can be recorded at the user computer, as well as other sensory data.

A step 720 allows the user at the user computer 100 or 150 to enter a command that will be directed to the remote unit. The remote unit will then perform that specified command at step 530. In this manner, commands can be entered by either a person at the user computer (step 720) or a person at the base station (step 620), and the remote unit will perform all such specified commands, as those commands are received. In addition, the sensory outputs from the remote unit can be received and displayed and recorded at both the base station and at the user computer. As noted above, certain data could also be recorded directly on site at the remote unit itself, using the data recorder 280. Thus certain important data could be recorded at more than one location (and in fact at three different locations) virtually simultaneously, if desired.

If desired, the troubleshooting features could be commanded to the remote unit from one of the user computers, using step 720, rather than from the base station using step 620. This is a design choice to be made by the overall system designer for the surveillance system of the present invention.

Once the user computer communicates with the base station at step 702, and essentially logs into the system, the human “remote user” at the user computer now has the ability to change parameters of the sensors of the remote unit, including the video camera for certain types of commands, such as position, zoom, recording mode, activating motion detection, creating a preset position, activating a touring functionality, pan, tilt, zoom, brightness, tint, contrast, and color video versus black and white video, etc. The sensors can be manually or automatically requested to transmit their current data, and this data can be polled by the cellular router 240. In addition, the sensor data or video data can be commanded to be recorded locally and/or transmitted to either the base station 60 or to one of the remote units 100, 150, for example. These commands would be entered at step 720.

The mode of recording could be using videotape, or a video DVD format, or other types of data format yet to be commercially used. A remote copy (recorded either at the base station or one of the user computers) would likely be more secure, however, using today's cellular systems, the bandwidth limitations would likely result in a lower quality of the video data, but not necessarily of other sensor data. Therefore, in many applications, a local recorded copy might be desired, using the data recorder 280 at the remote unit 12, for example.

When the user at one of the user computers communicates with the base station at step 704, this could be accomplished by using a WINDOWS-type display in which the user clicks on a particular icon that specifies a particular remote unit. This display could be of any type of presentation, but with WINDOWS-type technology, it would be simple to provide a different icon for each individual remote unit that is part of a surveillance system. Similarly, when the user at either a base station or one of the user computers desires to enter a new command at either step 620 or step 720, and is viewing the control panel of the selected remote unit (which can be seen at either step 610 or 710 of the flow chart of FIG. 4), then the typical WINDOWS-type displays of control panel functions could be utilized and made into a custom-type display for the surveillance system of the present invention. The types of commands discussed above could thereby be entered using this control panel-type display, including commands for adjusting the video camera settings, for example.

As an option, the remote unit itself could control the vehicular movements of an automobile or other type of mobile unit to which the remote unit is mounted. This could include a bomb disposal vehicle, for example, in which the base station or one of the user computers could command movements of not only the video camera (e.g., pan, tilt, zoom), but also could control the actual movements of the vehicle itself. In this situation, there would be outputs at the transceiver (e.g., the cellular router 240) that communicate to a controller in the vehicle itself, and the vehicle would have outputs that control the forward or reverse movements, and control the direction of the vehicle, in essence by controlling the steering wheel. In addition, the vehicle itself could have a robotic arm control output in which a pinhole camera could be mounted to the arm itself. This could either be the same robot arm that can be used to grab hold of a potential bomb so as to place it into a disposal container, or it could be on a separate robotic arm from the “grasping” robotic arm that can grab hold of a potential bomb. This type of system would generally use the type of hardware configuration depicted in FIG. 3, using an analog camera 400, since the camera itself might be damaged or destroyed when used with a bomb disposal vehicle. Some analog video cameras are very small in size, and are often referred to as “pinhole cameras,” as noted above.

It should be understood that the video camera can have additional settings adjusted by remote control in the present invention. For example, the video camera can have its brightness, tint, contrast, and other adjustments made using commands that are entered at either step 620 or 720 of the flow chart in FIG. 4. A more intelligent camera might be needed to accept some of these commands, such as an IP camera 200, as depicted in FIG. 2 (rather than a simplified analog camera 400 shown in FIG. 3). In addition to these various video controls, the camera could be commanded to take a single frame image, and that image could be either stored on site at the data recorder 280, or it could be transmitted over the cellular network to either the base station 60 or one of the user computers 100, 150.

Furthermore, the recording of video data itself could be commanded in real time using either step 620 or 720 of the flow chart of FIG. 4. Again, there can be local recording capability using the data recorder 280, and the starting or stopping times of this recording could be important so as to not have a data overflow at the bulk memory storage device 288 of that data recorder 280. Moreover, the remote unit can be instructed as to where the data is to be stored, as noted above; it could be either stored on-site, or transmitted over the Internet to the base station or to the remote user computers, or it could do both virtually simultaneously.

When the remote unit is initialized at step 510, this will typically cause the video camera itself to be automatically moved to its null positional setting. Part of the default mode 512 could not only begin scanning using the sensors of the remote unit (including the video camera), but could also be programmed to move the camera to a predetermined position with respect to its null setting. This default mode could thus be programmable for each individual remote unit, if desired. This would require a certain amount of extra intelligence for the remote unit, but a separate program could be utilized with an intelligent cellular router or an intelligent IP camera, for example. Such intelligence may not be available with current technology that is available off-the-shelf, however, future devices might have such programmability built into them without requiring further hardware modifications.

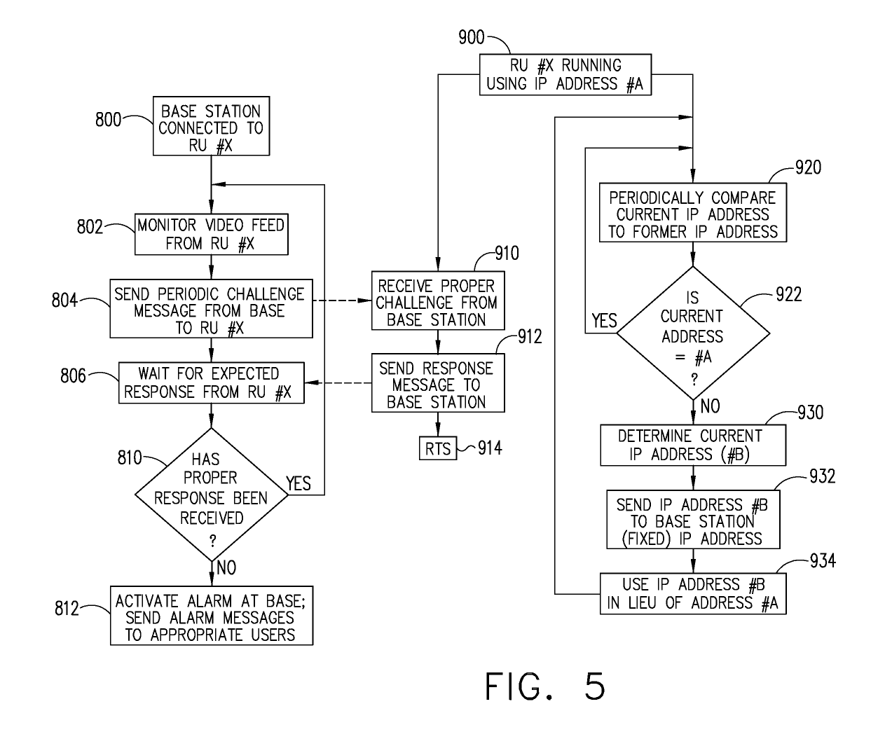

Referring now to FIG. 5, a flow chart of some other of the logical operations using the present invention is depicted. This example assumes a base station, such as the base station 60 depicted in FIG. 1, along with a remote unit, such as one of the remote units 12 or 22 also depicted in FIG. 1. The logic of FIG. 5 can be used with multiple remote units for a system having a single base station, in which the same logic in FIG. 5 can be used for any base station/remote unit system, regardless of how many remote units there are in the system, and also regardless as to how many individual users are tied into the base station (or a remote unit) of this system.

Beginning with the base station logic, a step 800 involves a base station that is connected to a remote unit, herein referred to as remote unit #X. At a step 802, the base station is monitoring the video feed from remote unit #X. The base station, once its communication has been established with remote unit #X, will send a periodic challenge message from the base station to that remote unit #X at a step 804. For this to occur, the base station must already be in communication with remote unit #X (which is one of the premises of step 800, above). This prior communication normally would involve the logic depicted in the flow chart of FIG. 4, in which the remote unit must inform the base station as to its current IP address. This is necessary, because the remote unit in the present invention can have a dynamic IP address.

After the periodic challenge message has been sent by use of step 804, the base station will now expect a particular type of response from the remote unit #X, at a step 806. The amount of time that the base unit will “wait” for this expected response can be programmed by the systems administrator for the base station system. For example, the expected response waiting period could be one minute, or any other amount of time that is selected as a “waiting period” for the expected response.

Once the expected response waiting period has “timed out,” the base station logic will arrive at a decision step 810 that determines whether or not a proper response has been received (or the logic could “immediately” jump to step 810 once the proper response is received at step 806). If the answer is YES, the logic flow is directed back to step 802, in which the base station continues to monitor the video feed from remote unit #X at step 802. On the other hand, if the proper response has not been received at step 810, then the logic is directed to a step 812 in which an alarm is activated at the base station. At step 812, alarm messages can be automatically sent to as many appropriate users, as desired (as set up by the systems administrator). This list of users to be notified also could be set up by some other supervisory user who has the authority to determine which users should be on the “list” for receiving the alarm message that a particular remote unit (such as remote unit #X) has not been in proper communication with the base station. Such alarm messages can automatically appear on the monitor screen at the base station itself (such as at the display 80 or the display 82 as seen on FIG. 1). In addition, alarm messages can automatically be sent by e-mail to any number of users in the base station system, and furthermore, alarm messages can be automatically generated and sent to particular pre-programmed telephone numbers, via cell phones and also to land-line telephones, if desired. Similar alarm messages could be sent by use of other methods of communication, as determined by the systems administrator or the supervisory user.

Referring again to FIG. 5, a step 900 involves remote unit #X operating under normal circumstances while using an IP address #A. At step 900, it can be assumed that the remote unit #X has been in proper communication with the base station, which corresponds to step 800 in the other portion of the logic flow of FIG. 5.

The control logic for remote unit #X either can be multi-tasking in nature, or it can contain nested “DO-loops,” in which certain logical steps are performed either independent of other logical steps, or are performed multiple times within a series of other logical steps. In FIG. 5, it is presumed that certain of the steps (i.e., steps 910-914) are performed independently from other steps (i.e., steps 920-934), and thus the remote unit #X is multi-tasking in nature.

At a step 910, remote unit #X receives a proper challenge from the base station. This corresponds to the periodic challenge message that was sent in step 804 of FIG. 5. Once remote unit #X receives the proper challenge, it will send an appropriate response message to the base station, at a step 912. This corresponds to a message that is received at the base station in the logic that is depicted at step 806 on FIG. 5. Once the response message has been sent at step 912, this routine terminates at a step 914, and returns back to the beginning step 900.

Another branch of the logic is directed to a step 920 in which the control logic of the remote unit #X periodically compares its current IP address to its former IP address. This is accomplished at a decision step 922, which determines if the current IP address is equal to the IP address #A (which was the former IP address found in step 900). If the answer is YES, then the logic flow is directed back to the beginning of step 920. If the answer is NO at step 922, the logic flow is directed to a step 930 which now determines the (new) current IP address. This new IP address will be referred to as IP address #B.

Now that the control logic of remote unit #X realizes that there is a new IP address, a step 932 sends IP address #B to the base station in a “standard” message, such as the message that is transmitted in step 522 of FIG. 4. Since the remote unit's IP address is dynamic, the base station by itself cannot “find” remote unit #X. However, the base station has a fixed IP address, and therefore, remote unit #X is able to generate a message and send it to that fixed IP address of the base station. This is what occurs in step 932, and once the base station receives that new address (i.e., IP address #B), the base station will begin using that new IP address for future communications to this particular remote unit (e.g., remote unit #X), which occurs at step 604 on FIG. 4. The remote unit #X will now begin using IP address #B in lieu of the previous address #A, in a step 934. The logic flow is now directed back to step 920, at which the remote unit #X will again periodically compare its current IP address to its former IP address.

It will be understood that the “challenge-response” feature described above with regard to the flow chart of FIG. 5 is only one possible method for automatically keeping a base station in communication with a specific remote unit. Other logical steps could be used having the same overall effect, but would have different individual steps, without departing from the principles of the present invention. Instead of using a challenge-response feature, the system could be programmed so that every remote unit periodically sends its current IP address to its corresponding base station upon the lapse of a certain predetermined amount of time. However, this does not seem like a very elegant method for using the present invention, and it would also require a certain amount of bandwidth for transmitting information that is not truly necessary, since the IP addresses of the remote units do not change literally every minute.

Although the IP addresses of the remote units are dynamic, they change infrequently enough that the challenge-response system described in FIG. 5 should suffice for most applications. On the other hand, if a real time video feed is critical for certain applications, or at least for particular time periods with regard to specific base stations and remote units, then the system could be programmed so that the specific remote units will automatically send their current IP addresses to their appropriate base stations every so many seconds, as desired by the systems administrator. This can be programmed into the remote unit software, as desired.

It will be understood that there are many other applications in which the present invention could be used that have not been described above, but which nevertheless fall within the principles of the present invention. For example, the present invention could be used in a motorcade, in which the remote unit could be mounted in a “lead vehicle,” and wirelessly transmits video data to a network, possibly including the INTERNET. This video data would then be transmitted over the network to a base station, as described above, particularly with reference to FIG. 1. Now that the video data is at the base station, one or more user computers can also establish communications through the same network (e.g., the INTERNET).

In the motorcade application, one or more of the user computers (such as those on FIG. 1 at 100 or 150) could be “mobile” computers that are mounted in other vehicles of the very same motorcade. In this manner, the user computers are essentially just as remote from the base station as is the remote unit itself, yet they can receive the video data feed substantially in real time. In this manner, security agents in the motorcade can keep the trailing vehicles in a safer position while the lead vehicle essentially performs reconnaissance, in real time. Both the lead vehicle and the trailing vehicles (i.e., those acting as “user computers” in the terminology of FIG. 1) are all connected wirelessly to the network, which could comprise the INTERNET, or a private wide area network, if desired.

This same overall arrangement could also be used in a situation where the remote unit is mounted to a bomb-disposal robot, and its video feed is directed through the base station, but then is re-directed back to a mobile “user computer” (such as the computer 100 or 150 on FIG. 1). In this manner, nearby police agents can be monitoring the video feed transmitted by the remote unit, substantially in real time. The user computer can be physically located relatively close to the robotic bomb disposal unit, but still at a safe distance from the danger area.

Another possible feature using the present invention is to have simultaneous viewing and recording, either at the base station, or at one of the user computers. In FIG. 1, the bulk memory 70 of base station 60 could be used to record the video data substantially in real time, as that data arrives over the network, via the link 54. In other words, the user at the base station 60 could be both viewing the video data and recording the video data simultaneously. The same functions could be performed by a user at user computer #1 or user computer #X, for example.

At user computer 100, the bulk memory device 110 can be used to store video data that is being received over the INTERNET, via the link 56. So the user at this user computer station could be both viewing the video data on the display 120 (substantially in real time), while simultaneously recording this video data on the bulk memory device 110. The same arrangement could be used with user computer #X, in which the bulk memory device 160 could record the data while it is being simultaneously displayed on the display screen 170. Having more than one location for recording the video data can provide additional “back-up” facilities for extremely important video information, as it is being received substantially in real time.

Further examples of applications for using the present invention are as follows:

{1} Using a portable video camera with a “local” video recording capability, which means that the video data will be stored at the remote unit, which is the same remote unit that contains the portable video camera. This could be used, for example, in a marked police car for use in a motorcade, for use in safety/traffic control, or for use in an internal police investigation. This remote unit also would have the capability for wirelessly transmitting real time video to a base station (or command center).

{2} Using a stationary video camera for surveillance of a confined space, such as an apartment room, hotel room, or an office. In this application the preferred video camera would be a pinhole device, for ease of concealment, and would be able to receive commands to control the camera's movements, including functions such as pan or tilt. In such a stationary application, the camera could be powered by standard “line voltage” alternating current, if desired. This remote unit also would have the capability for wirelessly transmitting real time video to a base station (or command center).

{3} Again using a stationary video camera for surveillance of a particular area, a digital video camera could be used, and additional functions can be remotely commanded, such as a zoom function. A likely use in this instance is where a law enforcement officer is positioned at location A, and is monitoring a location B with the video camera. In such a stationary application, the camera could be powered by standard “line voltage” alternating current, if desired. This remote unit also would have the capability for wirelessly transmitting real time video to a base station (or command center).

{4} Using a portable video camera (e.g., either an analog or digital camera), such camera can be mounted inside an ambulance. For this ambulance application, a real time wireless video signal can be transmitted to a base (monitoring) station, and the patient's situation can thus be monitored by medical personnel, for example at an emergency room of a hospital. The emergency room doctor, for example, would be able to send instructions for treating the emergency patient, perhaps by using the radio equipment already in the ambulance. In addition, the doctor would have “early” real time information about the emergency patient before that patient arrives, and the doctor could prepare accordingly.

{5} Using a portable video camera (e.g., either an analog or digital camera), such camera can be mounted on a fire truck. For this fire truck application, a real time wireless video signal can be transmitted to a base (monitoring) station, and thus allow real time monitoring of the emergency situation. For example, the fire chief at the monitoring station would be able to remotely assess the fire, and if necessary, call in further equipment and men. The fire chief, for example, would also be able to send instructions to the on-site firemen, for managing the fire.

{6} Using a pinhole video camera, such camera could be worn on the clothing of a law enforcement officer, and this would be packaged with a wireless transmitter for sending real time video signals to a base (monitoring) station. In one application, the law enforcement officer could be an undercover agent, and the video camera would be “hidden.” In another application, the law enforcement officer could be a SWAT team member, and the video signal being transmitted to the base station would allow a remote person (such as the SWAT commanding officer) to monitor the activities of the SWAT team, and provide instructions over a radio link used by the SWAT team. The SWAT team commander could be physically located at a stationary site (such as a police station), or could be physically located across the street in a mobile form of the monitoring station, such as a vehicle. As an option, the SWAT team member carrying the pinhole camera could also be carrying a video recording device, and so this video data could be stored directly on-site with the SWAT team member, and/or at the base station.

In all of the above example applications, the video data can be recorded at the base (monitoring) station, if desired. Moreover, if the remote video camera system includes a video data recording device, then the same video data can also be recorded at that remote site. In many situations, the remote site video data recorder will store evidence that might later be used in a legal proceeding, or at least as an aid for the law enforcement officers, fire department officials, or medical personnel.

It will be understood that the logical operations described in relation to the flow charts of FIGS. 4 and 5 can be implemented using sequential logic, such as by using microprocessor technology, or using a logic state machine, or perhaps by discrete logic; it even could be implemented using parallel processors. One preferred embodiment may use a microprocessor or microcontroller to execute software instructions that are stored in memory cells within an ASIC. In fact, the entire microprocessor, along with RAM and executable ROM, may be contained within a single ASIC, in one mode of the present invention. Of course, other types of circuitry could be used to implement these logical operations depicted in the drawings without departing from the principles of the present invention.

It will be further understood that the precise logical operations depicted in the flow charts of FIGS. 4 and 5, and discussed above, could be somewhat modified to perform similar, although not exact, functions without departing from the principles of the present invention. The exact nature of some of the decision steps and other commands in these flow charts are directed toward specific models of video cameras and communications systems and certainly similar, but somewhat different, steps would be taken for use with other models or brands of such systems in many instances, with the overall inventive results being the same.

All documents cited in the Background of the Invention and in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

The Invention claimed is:

1. A mobile video surveillance system that includes a mobile video unit, said mobile video unit comprising:
a video camera that detects image information, and generates a first video signal;
a first computer that receives said first video signal from said video camera, and outputs a second video signal that is based upon said first video signal;
a video data recording circuit that receives said second video signal from said processing circuit, and stores video information corresponding to at least a portion of said second video signal in a bulk memory storage device;
a wireless transmitter that receives said second video signal from said first computer and, substantially in real time, transmits to a network video information corresponding to at least a portion of said second video signal; and
a source of electrical power for said video camera, said first computer, said video data recording circuit, and said transmitter.

2. The mobile video surveillance system of claim 1, wherein: said first computer and said video data recording circuit include software processing components, comprising at least one of:
a web browser module; a web server module; a data compression module; a camera controller module that aims and zooms said video camera; a video data recorder controller module that starts and stops the recording of video data; a video data encoder module, and a video data decoder module.

3. The mobile video surveillance system of claim 1, wherein:
(a) said video camera comprises a digital video camera;
(b) said first computer and said wireless transmitter are part of a cellular router that includes a first processing circuit, a first computer-readable memory circuit, a cellular transceiver, and a first at least one input/output port;
(c) said video data recording circuit and said bulk memory storage device include a second processing circuit, a second computer-readable memory circuit, and a second at least one input/output port;
(d) said first processing circuit receives said first video signal from the video camera, and said second video signal is directed through said first at least one input/output port to said second at least one input/output port and to said second processing circuit;
(e) said second video signal is also directed to said wireless transmitter, as determined by said first processing circuit; and
(f) other data messages are communicated to said wireless transmitter, as determined by said first processing circuit.

4. The mobile video surveillance system of claim 3, wherein said bulk memory storage device comprises one of:
(a) a hard disk drive that is readily removable from said mobile video unit; and
(b) at least two hard disk drives, in which a first hard disk drive is internal to said video data recording circuit, and a second hard disk drive is external to said video data recording circuit and is readily removable from said mobile video unit.

5. The mobile video surveillance system of claim 3, wherein said at least one input/output port is in communication with at least one sensor, in which said at least one sensor comprises at least one of: a motion detector, a radiation detector, a radioactivity detector, an acoustic energy detector, and an olfactory sensor.

6. The mobile video surveillance system of claim 1, wherein:
(a) said video camera comprises a digital video camera;
(b) said first computer, said video data recording circuit, said bulk memory storage device, and said wireless transmitter are included in a portable device that comprises a first processing circuit, a first computer-readable memory circuit, a cellular transceiver, and at least one input/output port; and
(c) said first processing circuit controls transfer of data between said first computer-readable memory circuit, said cellular transceiver, and said at least one input/output port.

7. The mobile video surveillance system of claim 6, wherein said bulk memory storage device comprises one of:
(a) an internal hard disk drive that is not removable from said mobile video unit;
(b) an external hard disk drive that is readily removable from said mobile video unit; and
(c) at least two hard disk drives, in which a first hard disk drive is internal to said video data recording circuit, and a second hard disk drive is external to said video data recording circuit and is readily removable from said mobile video unit.

8. The mobile video surveillance system of claim 6, wherein said at least one input/output port is in communication with at least one sensor, in which said at least one sensor comprises at least one of: a motion detector, a radiation detector, a radioactivity detector, an acoustic energy detector, and an olfactory sensor.

9. The mobile video surveillance system of claim 1, further comprising: a video server that includes a third processing circuit, a third computer-readable memory circuit, an input video amplifier, an analog-to-digital (A/D) converter, and a third at least one input/output port;
wherein:
(a) said video camera comprises an analog video camera;
(b) said first computer and said wireless transmitter are part of a cellular router that includes a first processing circuit, a first computer-readable memory circuit, a cellular transceiver, and a first at least one input/output port;
(c) said video data recording circuit and said bulk memory storage device include a second processing circuit, a second computer-readable memory circuit, and a second at least one input/output port;
(d) said input video amplifier receives said first video signal from the video camera, and amplifies said first video signal, the amplified first video signal is directed to said A/D converter, and an output signal of the A/D converter is directed to said third processing circuit, which outputs a third video signal to said third at least one input/output port;
(e) said first at least one input/output port receives said third video signal, which is directed to said first processing circuit, and said second video signal is directed through a different port of said first at least one input/output port to said second at least one input/output port and to said second processing circuit;
(f) said second video signal is also directed to said wireless transmitter, as determined by said first processing circuit; and
(g) other data messages are communicated to said wireless transmitter, as determined by said first processing circuit.

10. The mobile video surveillance system of claim 9, wherein said bulk memory storage device comprises one of:
(a) a hard disk drive that is readily removable from said mobile video unit; and
(b) at least two hard disk drives, in which a first hard disk drive is internal to said video data recording circuit, and a second hard disk drive is external to said video data recording circuit and is readily removable from said mobile video unit.

11. The mobile video surveillance system of claim 9, wherein said at least one input/output port is in communication with at least one sensor, in which said at least one sensor comprises at least one of: a motion detector, a radiation detector, a radioactivity detector, an acoustic energy detector, and an olfactory sensor.

12. The mobile video surveillance system of claim 1, wherein said mobile video unit is mounted in a vehicle.

13. The mobile video surveillance system of claim 13, further comprising a receiver that is wirelessly in communication with said network and which receives instructions from a user positioned at a physically separate location over said network;
wherein said vehicle is left unmanned, and said video camera and said video data recording circuit are controlled by said received instructions.

14. A mobile video surveillance system, comprising:
(a) at least one mobile video unit having a first computer, a first memory circuit, a first communications port that is in communication with said network by way of a wireless transmitter/receiver, a video camera that generates a first video signal, and a first data recorder for storing video information; wherein:
(i) said first computer functions as a server for communicating with said network;
(ii) said first computer receives said first video signal and creates a second video signal that is stored in said first memory circuit;
(iii) said first computer receives said first video signal and creates a third video signal that is communicated to said first communications port, said wireless transmitter/receiver, and said network substantially in real time; and
(iv) said first communications port receives messages from said network, by way of said wireless transmitter/receiver, and directs said received messages to said first computer, in which said received messages may contain instructions for controlling said video camera and said first data recorder, using output signals provided by said first computer; and
(b) a base station that is physically separated from said at least one mobile video unit, having a second computer, a second memory circuit, a second communications port that is in communication with said network, and a first user interface that includes a first video monitor and a first user input device; wherein:
(i) said second communications port receives said third video signal, and directs it to said second computer;
(ii) said second computer displays said third video signal on said video monitor substantially in real time; and
(iii) said first user input device allows a user to enter commands that are communicated to said the first computer of said at least one mobile video unit, by way of said second computer, said second communications port, said network, and said first communications port.

15. The mobile video surveillance system of claim 14, wherein:
(a) said network comprises a world wide network of computers;
(b) said base station includes a web browser software module, and has a fixed IP address;
(c) said at least one mobile video unit includes a web browser software module, and has a dynamic IP address; and
(d) the first computer initiates contact between said base station and said at least one mobile video unit, by way of said world wide network of computers.

16. The mobile video surveillance system of claim 15, further comprising:
(a) at least one user computer that that is physically separated from said at least one mobile video unit, and is physically separated from said base station, said at least one user computer having a third memory circuit, a third communications port that is in communication with said network, and a second user interface that includes a second video monitor and a second user input device; wherein:
(i) said third communications port receives said third video signal, and directs it to said at least one user computer;
(ii) said at least one user computer displays said third video signal on said video monitor of said second user interface substantially in real time; and
(iii) said second user input device allows a different user to enter commands that are communicated to said the first computer of said at least one mobile video unit, by way of said at least one user computer, said third communications port, said network, and said first communications port.

17. The mobile video surveillance system of claim 16, wherein: said first computer may receive authorized commands from said base station, and also may receive authorized commands from said at least one user computer.

18. The mobile video surveillance system of claim 16, wherein: said at least one user computer remains linked to said base station to continue receiving said third video signal.

19. The mobile video surveillance system of claim 16, wherein: said at least one user computer begins communicating directly with said at least one mobile video unit to receive said third video signal, using said dynamic IP address of said at least one mobile video unit, thereby bypassing said base station.

20. The mobile video surveillance system of claim 14, wherein said base station further comprises a second data recorder for storing video information, and said second computer causes said third video signal to be stored on said second data recorder, substantially in real time.

21. The mobile video surveillance system of claim 16, wherein said at least one user computer further comprises a third data recorder for storing video information, and said at least one user computer causes said third video signal to be stored on said third data recorder, substantially in real time.

22. A method for maintaining remote video surveillance, said method comprising:
(a) providing a base station that is in communication with a network of computers, said base station having a first computer that has a fixed IP address;
(b) providing a remote unit that is in communication with said network of computers, said remote unit having a second computer that has a dynamic IP address, a wireless transmitter/receiver, a video camera, and a video data recorder, wherein said remote unit is physically separated from said base station;
(c) initializing said base station and initializing said remote unit;
(d) transmitting said dynamic IP address from said remote unit to said base station, using said fixed IP address of the base station; and
(e) after said base station recognizes said remote unit, transmitting video data from said remote unit to said base station.

23. The method of claim 22, further comprising the step of: sending commands from said base station to said remote unit, thereby allowing a user at said base station to remotely control said video camera and said data recorder.

24. The method of claim 22, further comprising the steps of:
(a) periodically sending a challenge message from said base station to said remote unit;
(b) waiting, at said base station, for a predetermined time interval to receive an appropriate response message from said remote unit after each challenge message has been sent; and
(c) after said predetermined time interval has elapsed without receiving said appropriate response message from said remote unit, generating an alarm state at said base station to inform at least one user of the failure to receive the appropriate response message from said remote unit.

25. The method of claim 22, further comprising the steps of:
(a) at said remote unit, periodically comparing a current IP address to a former IP address;
(b) if said current and former IP addresses are the same, then continuing normal operation; and
(c) if said current and former IP addresses are not the same, then transmitting the current IP address from said remote unit to said base station, using said fixed IP address of the base station, in an attempt to re-establish communications between said remote unit and said base station.
